(19) United States
(12) Patent Application Publication
(10) Pub. No.: US 2025/0140821 A1
(43) Pub. Date: May 1, 2025

(54) POSITIVE ELECTRODE ACTIVE MATERIAL LAYER, LITHIUM-ION BATTERY, AND METHOD FOR MANUFACTURING POSITIVE ELECTRODE ACTIVE MATERIAL LAYER

(71) Applicant: TOYOTA JIDOSHA KABUSHIKI KAISHA, Aichi-ken (JP)

(72) Inventor: Daichi KOSAKA, Toyota-shi (JP)

(21) Appl. No.: 18/912,598

(22) Filed: Oct. 11, 2024

(30) Foreign Application Priority Data
Oct. 25, 2023 (JP) 2023-183173

(51) Int. Cl. H01M 4/40; C01D 15/00; H01M 4/02; H01M 4/36; H01M 4/58; H01M 4/62; H01M 10/0525

(52) U.S. Cl. CPC H01M 4/405; C01D 15/00; H01M 4/366; H01M 4/5825; H01M 4/62; H01M 10/0525; H01M 2004/028

(57) ABSTRACT

The present disclosure provides a positive electrode active material layer which can improve battery capacity, a lithium-ion battery comprising such a positive electrode active material layer, and a method for manufacturing such a positive electrode active material layer. The positive electrode active material layer 20 of the present disclosure comprises a positive electrode active material 21a and a lithium alloy 22a of lithium and a metal element. The positive electrode active material is coated with a carbon material, the metal element has an alloying potential with lithium of 0.5V (vs. Li/Li⁺) or more, and the lithium alloy is arranged on a surface of closer to the positive electrode current collector and/or separator of the positive electrode active material layer. A lithium-ion battery of the present disclosure comprises a positive electrode active material layer of the present disclosure, which is interposed between a positive electrode current collector and a separator.

### FIELD

The present disclosure relates to a positive electrode active material layer, a lithium-ion battery, and a method for manufacturing a positive electrode active material layer.

### BACKGROUND

Some of the lithium ions supplied from a positive electrode active material of a lithium-ion battery react with an electrolyte on the surface of a negative electrode active material layer and are consumed to form a solid electrolyte interface (SEI). As a result, a problem arises in that battery capacity decreases. Thus, in order to make maximum use of the positive electrode active material, it is necessary to supplement the lithium ions consumed in the formation of the SEI in the negative electrode active material layer, and technologies for this purpose have been developed.

For example, Patent Literature 1 discloses a positive electrode for secondary batteries, comprising a positive electrode mixture layer (positive electrode active material layer) in which a positive electrode active material is mixed with a lithium alloy.

### CITATION LIST

### Patent Literature

[Ptl 1] Japanese Unexamined PCT Publication (Kohyo) No. 2021-520614

### SUMMARY

### Technical Problem

Even in batteries with a positive electrode active material layer containing a positive electrode active material and a lithium alloy, the desired battery capacity may not be obtained, and thus, there is room for improvement in terms of battery capacity.

The present disclosure aims to provide a positive electrode active material layer which can improve battery capacity, a lithium-ion battery comprising such a positive electrode active material layer, and a method for manufacturing such a positive electrode active material layer.

### Solution to Problem

The present inventors have discovered that the above object can be achieved by the following means.

### <Aspect 1>

A positive electrode active material layer, which is interposed between a positive electrode current collector and a separator, wherein
the positive electrode active material layer comprises a positive electrode active material and a lithium alloy of lithium and a metal element,
the positive electrode active material is coated with a carbon material,
the metal element has an alloying potential with lithium of 0.5 V (vs. Li/Li⁺) or more, and
the lithium alloy is arranged on a surface of the positive electrode active material layer that is closer to the positive electrode current collector and/or on a surface of the positive electrode active material layer that is closer to the separator.

### <Aspect 2>

The positive electrode active material layer according to Aspect 1, wherein the lithium alloy forms a lithium alloy layer.

### <Aspect 3>

The positive electrode active material layer according to Aspect 2, wherein the lithium alloy layer has a thickness of 1 μm or more and 20 μm or less.

### <Aspect 4>

The positive electrode active material layer according to any one of Aspects 1 to 3, wherein the positive electrode active material is an olivine positive electrode active material.

### <Aspect 5>

The positive electrode active material layer according to Aspect 4, wherein the olivine positive electrode active material is at least one selected from lithium ferrous phosphate, lithium ferromanganese phosphate, lithium manganese phosphate, and lithium cobalt phosphate.

### <Aspect 6>

The positive electrode active material layer according to any one of Aspects 1 to 5, wherein the metal element is at least one selected from bismuth, antimony, and tin.

### <Aspect 7>

The positive electrode active material layer according to any one of Aspects 1 to 6, wherein the ratio of a mass of the positive electrode active material to a mass of the lithium alloy is 3.0 or more and 15.0 or less.

### <Aspect 8>

The positive electrode active material layer according to any one of Aspects 1 to 7, wherein the positive electrode active material layer from which the lithium alloy is excluded has a thickness of 20 μm or more and 300 μm or less.

### <Aspect 9>

A lithium-ion battery, comprising:
the positive electrode current collector,
the separator, and
the positive electrode active material layer according to any one of Aspects 1 to 8, which is interposed between the positive electrode current collector and the separator.

### <Aspect 10>

A lithium-ion battery, comprising:
a positive electrode current collector,
a separator, and
a positive electrode active material layer, which is interposed between the positive electrode current collector and the separator, wherein
the positive electrode active material layer contains a positive electrode active material and a metal element,
the positive electrode active material is coated with a carbon material,
the metal element has an alloying potential with lithium of 0.5 V (vs. Li/Li⁺) or more, and
the metal element is arranged on a surface of the positive electrode active material layer that is closer to the positive electrode current collector and/or on a surface of the positive electrode active material layer that is closer to the separator.

### <Aspect 11>

A method for manufacturing the positive electrode active material layer according to any one of Aspects 1 to 8, comprising the following steps:
(a) applying a first slurry containing the lithium alloy and a first dispersion medium onto a base material,
(b) applying a second slurry containing the positive electrode active material and a second dispersion medium after the step (a),
(c) removing the first and second dispersion media by drying to obtain a laminate; and
(d) pressing the laminate.

### <Aspect 12>

The method according to Aspect 11, wherein the base material is a positive electrode current collector.

### <Aspect 13>

The method according to Aspect 11 or 12, further comprising, before the step (b), removing the first dispersion medium by drying to obtain a preliminary lithium alloy layer.

### <Aspect 14>

The method according to Aspect 13, further comprising pressing the preliminary lithium alloy layer to obtain a lithium alloy layer.

### <Aspect 15>

The method according to any one of Aspects 11 to 14, wherein the first and second dispersion media are the same dispersion medium.

### Advantageous Effects of Invention

According to the present disclosure, there can be provided a positive electrode active material layer which can improve battery capacity, a lithium-ion battery comprising such a positive electrode active material layer, and a method for manufacturing such a positive electrode active material layer.

### BRIEF DESCRIPTION OF DRAWINGS

FIG. 1 is a schematic cross-sectional view showing an example of the positive electrode active material layer of the present disclosure.

FIG. 2 is a schematic cross-sectional view showing an example of the positive electrode active material layer of the present disclosure.

FIG. 3 is a schematic cross-sectional view of a positive electrode active material layer of a Comparative Example.

FIG. 4 is a schematic cross-sectional view showing an example of the battery of the present disclosure.

### DESCRIPTION OF EMBODIMENTS

The embodiments of the present disclosure will be described in detail below. It is noted that the present disclosure is not limited to the following embodiments, and various changes can be made within the scope of the spirit of the disclosure.

### <<Positive Electrode Active Material Layer>>

The positive electrode active material layer of the present disclosure is interposed between a positive electrode current collector and a separator, and comprises a positive electrode active material and a lithium alloy of lithium and a metal element. The positive electrode active material is coated with a carbon material, the metal element has an alloying potential with lithium of 0.5V (vs. Li/Li⁺) or more, and the lithium alloy is arranged on a surface of the positive electrode active material layer that is closer to the positive electrode current collector and/or on a surface of the positive electrode active material layer that is closer to the separator. It is noted that “the lithium alloy is arranged on a surface of the positive electrode active material layer that is closer to the positive electrode current collector and/or on a surface of the positive electrode active material layer that is closer to the separator” as used herein means that the lithium alloy is arranged at a higher density on the surface of the positive electrode active material layer that is closer to the positive electrode current collector or on the surface of the positive electrode active material layer that is closer to the separator than in other parts of the positive electrode active material layer, and in particular, means that the lithium alloy is disposed only on the surface of the positive electrode active material layer that is closer to the positive electrode current collector and/or on the surface of the positive electrode active material layer that is closer to the separator.

The present inventors have considered that one of the reasons why the desired battery capacity cannot be obtained even in batteries comprising a positive electrode active material layer containing a positive electrode active material and a lithium alloy is the reaction that would occur between the carbon material coating the positive electrode active material and a lithium alloy. Specifically, without being bound by theory, this is presumed as follows. Since the oxidation-reduction potential of a lithium alloy is low, it is believed that during an initial charging, the lithium alloy reacts with the carbon material coating the positive electrode active material, damaging the carbon material coating. As a result, it is believed that the adhesion between the positive electrode active material and the carbon material is reduced and the resistance is increased, making it impossible to obtain the desired battery capacity.

In connection thereto, the present inventors have discovered that when a positive electrode active material layer containing a positive electrode active material coated with a carbon material and a lithium alloy of lithium and a predetermined metal element has the lithium alloy arranged on the surface of the positive electrode active material layer that is closer to the positive electrode current collector and/or on the surface of the positive electrode active material layer that is closer to the separator, battery capacity can be improved. Without being bound by theory, the reason for this is presumed to be as follows. Specifically, it is believed that this is because by arranging the lithium alloy on the surface of the positive electrode active material layer that is closer to the positive electrode current collector and/or on the surface of the positive electrode active material layer that is closer to the separator, the contact area between the carbon material coating the positive electrode active material and the lithium alloy can be made smaller than when the positive electrode active material and the lithium alloy are mutually dispersed in the positive electrode active material layer.

The positive electrode active material layer of the present disclosure will be described below with reference to the appropriate drawings. It is noted that the dimensional relationships in each drawing do not reflect the actual dimensional relationships.

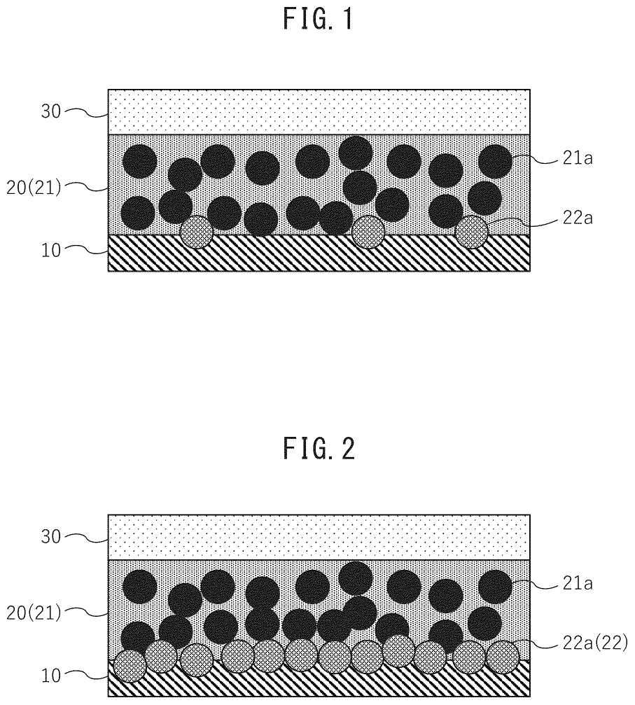

As shown in FIGS. 1 and 2, a positive electrode active material layer 20 of the present disclosure comprises a positive electrode active material 21a and a lithium alloy 22a of lithium and a metal element. The positive electrode active material layer optionally comprises a conductive aid and a binder. When the lithium-ion battery of the present disclosure is a solid-state battery, the positive electrode active material layer may optionally comprise a solid electrolyte.

As shown in FIGS. 1 and 2, the positive electrode active material layer 20 of the present disclosure is interposed between a positive electrode current collector 10 and a separator 30.

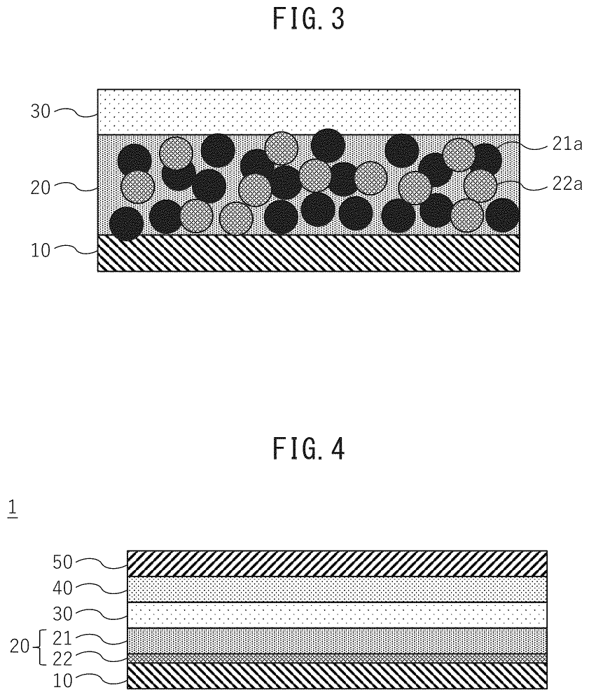

As shown in FIG. 1, the lithium alloy 22a is arranged on the surface closer to the positive electrode current collector 10. Though not illustrated, the lithium alloy 22a may be arranged on the surface closer to the separator 30. It is believed that by adopting this configuration, the contact area between the carbon material coating the positive electrode active material 21a and the lithium alloy 22a can be made smaller than when the positive electrode active material 21a and the lithium alloy 22a are mutually dispersed in the positive electrode active material layer 20, as shown in FIG. 3.

It is noted that, as shown in FIG. 2, the lithium alloy 22a may form a lithium alloy layer 22 on the surface closer to the positive electrode current collector 10. Though not illustrated, the lithium alloy 22a may form a lithium alloy layer on the surface closer to the separator 30.

When the lithium alloy 22a is arranged on the surface closer to the positive electrode current collector 10, it is considered that the durability of the battery is improved. Though not to be bound by theory, this is presumed as follows. Specifically, during the process of repeated charging and discharging, the ions of the metal element, which are generated when lithium ions are released from the lithium alloy during charging, may move toward the negative electrode current collector and be deposited on the negative electrode current collector as an elemental metal. When this precipitate is generated locally, it becomes a dendrite, and when it grows and reaches the positive electrode current collector, a short circuit is caused. It is believed that when the lithium alloy 22a is arranged on the surface closer to the positive electrode current collector 10, the distance between the metal element and the negative electrode current collector is longer than when the lithium alloy 22a is arranged on the surface closer to the separator 30, which makes local dendrite precipitation less likely to occur, and as a result, the possibility of the short circuit described above occurring can be reduced.

### <Positive Electrode Active Material>

The positive electrode active material is coated with a carbon material.

The positive electrode active material may be an olivine positive electrode active material.

The olivine positive electrode active material may be at least one selected from lithium ferrous phosphate, lithium ferromanganese phosphate, lithium manganese phosphate, and lithium cobalt phosphate.

By coating the positive electrode active material with the carbon material, the electronic conductivity of the positive electrode active material can be improved. In particular, olivine positive electrode active materials, due to having lower electronic conductivity than ternary positive electrode active materials such as nickel-cobalt-manganese (NCM), is effectively coated with the carbon material.

The method of coating the positive electrode active material with the carbon material is not particularly limited, and examples thereof include a method of coating the positive electrode active material with a predetermined organic compound and firing the positive electrode active material coated with the organic compound in an inert atmosphere to carbonize the organic compound.

Regarding the present disclosure, a commercially available positive electrode active material coated with the carbon material may be used.

### <Lithium Alloy>

The lithium alloy can provide lithium ions, which can prevent the lithium ions of the positive electrode active material from being consumed in the formation of SEI in the negative electrode active material layer. As a result, it is possible to make maximum use of the positive electrode active material, and the reversible capacity can be increased.

The metal element forming the lithium alloy has an alloying potential with lithium of 0.5 V (vs. Li/Li⁺) or more. According to this, the lithium alloy is stabilized and the lithium alloy can be easily handled. This alloying potential may be 0.6 V (vs. Li/Li⁺) or more, 0.7 V (vs. Li/Li⁺) or more, or 0.8 V (vs. Li/Li⁺) or more, and may be 1.5 V (vs. Li/Li⁺) or less, 1.4 V (vs. Li/Li⁺) or less, 1.3 V (vs. Li/Li⁺) or less, 1.2 V (vs. Li/Li⁺) or less, 1.1 V (vs. Li/Li⁺) or less, or 1.0 V (vs. Li/Li⁺) or less.

The alloying potential (vs. Li/Li⁺) is the electrode potential of the electrode reaction in formula (1), and is expressed with the electrode potential of lithium in formula (2) below as a reference:

xLi⁺+M+xe⁻←→LiₓM (1)

Li⁺+e⁻←→Li (2)

The alloying potential (vs. Li/Li⁺) can be measured as the unipolar potential obtained when the alloy is immersed in a Li salt solution.

The metal element may be at least one selected from bismuth, antimony, and tin.

The lithium alloy may be prepared by a conventional method or may be a commercially available product. Examples of the method for preparing the lithium alloy include, but are not limited to, a method of mixing lithium and a metal element in a mortar in an inert atmosphere.

The ratio of the mass of the positive electrode active material to the mass of the lithium alloy in the positive electrode active material layer of the present disclosure may be 3.0 or more and 15.0 or less. This ratio may be 3.5 or more, 4.0 or more, 5.0 or more, or 6.0 or more, and may be 14.0 or less, 13.0 or less, 12.0 or less, or 11.0 or less. Due to the high-capacity properties of the material itself, the lithium alloy can contribute to increased battery capacity even when added in a small amount within the above range. It is noted that this ratio can be appropriately designed depending on the types of the positive electrode active material and the lithium alloy used.

The ratio of the volume of the positive electrode active material to the volume of the lithium alloy in the present disclosure may be 5.0 or more, 6.0 or more, 7.0 or more, 8.0 or more, or 8.5 or more, and may be 20.0 or less, 19.0 or less, 18.0 or less, 17.0 or less, or 16.5 or less. It is noted that this ratio can be appropriately designed depending on the types of the positive electrode active material and the lithium alloy used.

When the lithium alloy forms a lithium alloy layer on the surface that is closer to the positive electrode current collector and/or on the surface that is closer to the separator, the thickness of the lithium alloy layer may be 1 μm or more and 20 μm or less. The thickness may be 2 μm or more, 3 μm or more, 4 μm or more, or 5 μm or more, and may be 18 μm or less, 16 μm or less, 15 μm or less, 14 μm or less, 12 μm or less, 11 μm or less, or 10 μm or less.

It is noted that the thickness of the positive electrode active material layer from which the lithium alloy is excluded may be 20 μm or more and 300 μm or less. This thickness may be 40 μm or more, 60 μm or more, 70 μm or more, 80 μm or more, or 90 μm or more, and may be 250 μm or less, 200 μm or less, 150 μm or less, 130 μm or less, 120 μm or less, or 110 μm or less. The positive electrode active material layer from which the lithium alloy is excluded may be, in particular, the positive electrode active material layer from which the lithium alloy layer is excluded. It is noted that in the present disclosure, the positive electrode active material layer from which the lithium alloy or lithium alloy layer is excluded may be referred to as the layer containing the positive electrode active material (for example, LFP).

By adjusting the content of the lithium alloy in the positive electrode active material layer, the lithium alloy can be prevented from forming a layer or caused to form a layer. Specifically, the content of the lithium alloy can be reduced to prevent the lithium alloy from forming a layer, and the content of the lithium alloy can be increased to cause the lithium alloy to form a layer.

### <Conductive Aid>

As the conductive aid, a known conductive aid which is used in lithium-ion batteries may be used. Specifically, carbon materials such as Ketjen black (KB), vapor grown carbon fiber (VGCF), acetylene black (AB), carbon nanotubes (CNT), carbon nanofibers (CNF), carbon black, coke, or graphite may be used. Alternatively, a metal material which can withstand the environment during use of the battery may also be used. As the conductive aid, one type may be used alone, or a combination of two or more types may be used. The conductive aid may have various shapes such as powder-like or fiber-like. The amount of the conductive aid contained in the positive electrode active material layer is not particularly limited.

### <Binder>

As the binder, a known binder which is used in lithium-ion batteries may be used. For example, styrene butadiene rubber (SBR) binders, carboxymethyl cellulose (CMC) binders, acrylonitrile butadiene rubber (ABR) binders, butadiene rubber (BR) binders, polyvinylidene fluoride (PVDF) binders, and polytetrafluoroethylene (PTFE) binders may be used. One type of binder may be used alone, or a combination of two or more types may be used. The amount of binder contained in the positive electrode active material layer is not particularly limited.

### <Solid Electrolyte>

The material of the solid electrolyte is not particularly limited, and any material which can be used as a solid electrolyte used in lithium-ion batteries can be used. For example, the solid electrolyte may be a sulfide solid electrolyte, an oxide solid electrolyte, or a polymer electrolyte.

Examples of sulfide solid electrolytes include, but are not limited to, sulfide amorphous solid electrolytes, sulfide crystalline solid electrolytes, and argyrodite solid electrolytes. Specific examples of sulfide solid electrolytes include, but are not limited thereto, Li₂S-P₂S₅-based electrolytes (Li₇P₃S₁₁, Li₃PS₄, LigP₂S₉, etc.), Li₂S-SiS₂, LiI-Li₂S-SiS₂, LiI-Li₂S-P₂S₅, LiI-LiBr-Li₂S-P₂S₅, Li₂S-P₂S₅-GeS₂ (Li₁₃GeP₃S₁₆, Li₁₀GeP₂S₁₂, etc.), LiI-Li₂S-P₂O₅, LiI-Li₃PO₄-P₂S₅, or Li₇₋ₓPS₆₋ₓClₓ; or combinations thereof.

Examples of oxide solid electrolytes include, but are not limited to, Li₇La₃Zr₂O₁₂, Li₇₋ₓLa₃Zr₁₋ₓNbₓO₁₂, Li₇₋₃ₓLa₃Zr₂AlₓO₁₂, Li₃xLa_{2/3-x}TiO₃, Li₁₊ₓAlₓTi₂₋ₓ(PO₄)₃, Li₁₊ₓAlₓGe₂₋ₓ(PO₄)₃, Li₃PO₄, or Li₃₊ₓPO₄₋ₓNₓ (LiPON).

The sulfide solid electrolyte and the oxide solid electrolyte may be a glass or crystallized glass (glass ceramic).

Examples of polymer electrolytes include, but are not limited to, polyethylene oxide (PEO), polypropylene oxide (PPO), and copolymers thereof.

### <<Method for Manufacturing Positive Electrode Active Material Layer>>

The method for manufacturing a positive electrode active material layer of the present disclosure comprises the following steps: (a) applying a first slurry containing a lithium alloy and a first dispersion medium onto a base material; (b) applying a second slurry containing a positive electrode active material and a second dispersion medium after the step (a); (c) removing the first and second dispersion media by drying to obtain a laminate; and (d) pressing the laminate.

### <First Slurry Application Step>

The method of the present disclosure comprises (a) applying a first slurry containing a lithium alloy and a first dispersion medium onto a base material.

Regarding the lithium alloy, reference can be made to the above description regarding the positive electrode active material layer of the present disclosure.

The first dispersion medium is not particularly limited as long as it can disperse the lithium alloy and does not alter the lithium alloy. Examples of the first dispersion medium include alcohols, glycols, cellosolve, amines, ketones, carboxylic acid amides, phosphoric acid amides, sulfoxides, carboxylic acid esters, phosphoric acid esters, ethers, and nitriles. Specific examples thereof include ethanol, 2-propanol, methyl ethyl ketone, and N-methyl-2-pyrrolidone.

The base material may be the positive electrode current collector. By using the positive electrode current collector as the base material, the lithium alloy layer can be formed directly on the positive electrode current collector.

The base material may be the separator. By using the separator as the base material, the lithium alloy layer can be formed directly on the separator.

Examples of the application method include a metal mask printing method, an electrostatic application method, a dip coating method, a spray coating method, a roller coating method, a doctor blade method, a gravure coating method, and a screen printing method.

### <Second Slurry Application Step>

The method of the present disclosure comprises applying a second slurry containing a positive electrode active material and a second dispersion medium after the step (a).

Regarding the positive electrode active material, reference can be made to the above description regarding the positive electrode active material of the present disclosure.

The second dispersion medium is not particularly limited as long as it can disperse the positive electrode active material and does not alter the positive electrode active material. Examples of the second dispersion medium include alcohols, glycols, cellosolve, amines, ketones, carboxylic acid amides, phosphoric acid amides, sulfoxides, carboxylic acid esters, phosphoric acid esters, ethers, and nitriles. Specific examples thereof include ethanol, 2-propanol, methyl ethyl ketone, and N-methyl-2-pyrrolidone.

The first and second dispersion media in the method of the present disclosure may be the same dispersion medium. By using such a method even when, for example, the second slurry is applied directly onto the first slurry, each slurry layer can be formed without being affected by the surface tension caused by different dispersion media, i.e., without excessive mixing of the components of the first and second slurries.

The first and second slurries each may contain a binder. By using the same binder in each slurry, the same effect can be obtained as in the case where the dispersion media are the same.

Furthermore, for example, by making the first slurry highly viscous through increasing the solid content concentration of the first slurry, even when the second slurry is applied directly onto the first slurry, it is possible to effectively suppress mixing of the components of the first and second slurries.

### <Drying Step>

The method of the present disclosure comprises (c) removing the first and second dispersion media by drying to obtain a laminate.

The drying temperature, drying time, etc., can be appropriately designed depending on the content, boiling point, etc., of the dispersion media.

The method of the present disclosure can further comprise removing the first dispersion medium by drying to obtain a preliminary lithium alloy layer before the step (b). By using such a method, the dispersion media and binders of the first and second slurries can be selected without any particular restrictions.

### <Pressing Step>

The method of the present disclosure comprises (d) pressing the laminate. According to this method, the number of presses can be reduced to one, and thus, the production cost is low. Examples of a pressing method include methods such as roller pressing.

The method of the present disclosure can further comprise pressing the preliminary lithium alloy layer to obtain a lithium alloy layer. By using this method, the second slurry can be applied on the densified lithium alloy layer, suppressing the penetration of the positive electrode active material into the lithium alloy layer, and as a result, the frequency of contact between the lithium alloy and the carbon material coating the positive electrode active material can be reduced.

It is noted that the positive electrode active material layer of the present disclosure can also be manufactured by a method other than the foregoing. For example, the lithium alloy layer can be formed on the positive electrode current collector by first immersing the positive electrode current collector in an electrolytic solution containing the metal element constituting the lithium alloy to perform electrolytic plating. Thereafter, by performing the steps of applying a slurry containing the positive electrode active material, drying, and pressing in the same manner as described above, thereby forming the layer containing the positive electrode active material, the positive electrode active material layer of the present disclosure can be manufactured.

### <<Lithium-Ion Battery>>

As shown in FIG. 4, a lithium-ion battery 1 of the present disclosure comprises a positive electrode current collector 10, a separator 30, and a positive electrode active material layer 20 of the present disclosure, which is interposed between the positive electrode current collector 10 and the separator 30. Specifically, the lithium-ion battery 1 of the present disclosure comprises the positive electrode current collector 10, the positive electrode active material layer 20 of the present disclosure, and the separator 30 in this order. The lithium-ion battery 1 of the present disclosure may comprise the positive electrode current collector 10, the positive electrode active material layer 20 of the present disclosure, the separator 30, a negative electrode active material layer 40, and a negative electrode current collector 50 in this order. Though FIG. 4 shows an aspect in which the lithium alloy layer 22 is arranged on the surface that is closer to the positive electrode current collector, the lithium-ion battery 1 of the present disclosure is not limited to this aspect. Specifically, the lithium alloy may not form a layer, or the lithium alloy or the lithium alloy layer may be arranged on the surface that is closer to the separator.

The lithium-ion battery of the present disclosure may be a liquid-based battery containing an electrolytic solution as the electrolyte layer, or may be a solid-state battery having a solid electrolyte layer as the electrolyte layer. The electrolyte layer in a liquid-based battery may be one in which a separator is impregnated with an electrolytic solution. The solid electrolyte layer in a solid-state battery may have the function of a separator. It is noted that regarding the present disclosure, “solid-state battery” means a battery which uses at least a solid electrolyte as the electrolyte, and thus, solid-state batteries may use a combination of a solid electrolyte and a liquid electrolyte as the electrolyte. The solid-state battery of the present disclosure may be an all-solid-state battery, i.e., a battery using only a solid electrolyte as the electrolyte.

It is noted that in the lithium-ion battery of the present disclosure, lithium ions are desorbed from the lithium alloy during initial charging and discharging, and the metal element constituting the lithium alloy remains.

Thus, after initial charging and discharging, the lithium-ion battery of the present disclosure may be a lithium-ion battery comprising:
a positive electrode current collector,
a separator, and
a positive electrode active material layer, which is interposed between the positive electrode current collector and the separator, wherein
the positive electrode active material layer contains a positive electrode active material and a metal element;
the positive electrode active material is coated with a carbon material.
the metal element has an alloying potential with lithium of 0.5 V (vs. Li/Li⁺) or more, and
the metal element is arranged on the surface of the positive electrode active material layer that is closer to the positive electrode current collector and/or on the surface of the positive electrode active material layer that is closer to the separator.

### <Positive Electrode Current Collector>

The positive electrode current collector may be composed of a known metal or the like which can be used as the positive electrode current collector of a lithium-ion battery. Examples of such metals include a metal material containing at least one element selected from the group consisting of Cu, Ni, Al, V, Au, Pt, Mg, Fe, Ti, Pb, Co, Cr, Zn, Ge, In, Sn, and Zr. The form of the positive electrode current collector is not particularly limited, and may be in various forms such as foil, mesh, and porous. The positive electrode current collector may be one in which the metal described above is vapor-deposited and plated on the surface of the base material.

### <Positive Electrode Active Material Layer>

Regarding the positive electrode active material layer of the present disclosure, reference can be made to the above description regarding the positive electrode active material layer of the present disclosure.

### <Separator>

As the separator, a known separator which can be used in lithium-ion batteries may be used. For example, the separator may be composed of a resin such as polyethylene (PE), polypropylene (PP), polyester, or polyamide. The separator may have a single layer structure or a multilayer structure. As a multilayer structure separator, for example, a separator with a multi-layer structure made of the resin described above, for example, a separator having a two-layer structure of PE/PP, a separator having a three-layer structure of PP/PE/PP or PE/PP/PE, etc., can be used. The separator may be composed of a nonwoven fabric such as a cellulose nonwoven fabric, a resin nonwoven fabric, or a glass fiber nonwoven fabric. The thickness of the separator is not particularly limited, and may be, for example, 5 μm or more and 1 mm or less.

When the lithium-ion battery of the present disclosure is a liquid-based battery, the separator may be impregnated with an electrolytic solution to form an electrolyte layer.

### (Electrolytic Solution)

The electrolytic solution contains a lithium salt and a solvent. Examples of lithium salts include lithium hexafluorophosphate (LiPF₆), lithium tetrafluorophosphate (LiBF₄), lithium perchlorate (LiClO₄), lithium hexafluoroarsenate (LiAsF₆), lithium trifluoromethanesulfonate (LiCF₃SO₃), and lithium bis(trifluoromethanesulfonyl)imide (Li(CF₃SO₂)₂N). Examples of solvents include carbonic esters, cyclic esters (ethylene carbonate (EC), propylene carbonate (PC), etc.), chain esters (dimethyl carbonate (DMC), diethyl carbonate (DEC), ethylmethyl carbonate (EMC), etc.), aliphatic carboxylic acid esters (methyl formate (MF), etc.), γ-lactones (γ-butyrolactone (BL), etc.), chain ethers (1,2-dimethoxyethane (DME), etc.), or solvents in which some of these are combined. Among these, the solvent may be one containing an aprotic polar organic solvent, a cyclic carbonate compound (high dielectric constant, high viscosity) such as EC, and a chain carbonate compound such as DEC. The solvent may be an ionic liquid.

When the lithium-ion battery of the present disclosure is a solid-state battery, the solid electrolyte layer can function as a separator.

The solid electrolyte layer contains a solid electrolyte. Regarding the solid electrolyte, reference can be made to the above description regarding the positive electrode active material layer of the present disclosure.

### <Negative Electrode Active Material Layer>

The negative electrode active material layer contains a negative electrode active material and can optionally contain a conductive aid and a binder. When the lithium-ion battery of the present disclosure is a solid-state battery, the negative electrode active material layer can optionally contain a solid electrolyte.

Any known active material may be used as the negative electrode active material. For example, as the negative electrode active material, silicon-based active materials such as silicon, silicon alloys, and silicon oxide; carbon-based active materials such as graphite and hard carbon; various oxide-based active materials such as lithium titanate; metallic lithium, lithium alloys, etc., can be used. One type of negative electrode active material may be used alone, or two or more types may be used in combination. The negative electrode active material may be, for example, in the form of particles, and the size thereof is not particularly limited.

Regarding the conductive aid, binder, and solid electrolyte, reference can be made to the above descriptions regarding the positive electrode active material layer of the present disclosure.

### <Negative Electrode Current Collector>

Regarding the negative electrode current collector, reference can be made to the above description regarding the positive electrode current collector of the present disclosure.

### EXAMPLES

### Example 1

### <Production of Evaluation Cell>

### (Slurry Preparation Step)

A first slurry was prepared by mixing a lithium bismuth (Li₃Bi) alloy as the lithium alloy and a binder in N-methyl-2-pyrrolidone (NMP) as the first dispersion medium. A second slurry was prepared by mixing lithium ferrous phosphate (LFP) as the olivine positive electrode active material coated with a carbon material, a conductive aid, and a binder in NMP as the second dispersion medium.

### (First Slurry Application Step, Drying Step, and Pressing Step)

The first slurry was applied onto an aluminum (Al) foil as the positive electrode current collector. Thereafter, the NMP as the first dispersion medium was removed by drying to obtain a preliminary lithium alloy layer. The obtained preliminary lithium alloy layer was pressed to obtain a lithium alloy layer.

### (Second Slurry Application Step, Drying Step, and Pressing Step)

The second slurry was applied onto the lithium alloy layer. Thereafter, the layer obtained through removing the NMP as the second dispersion medium by drying was pressed to form a positive electrode active material layer on the positive electrode current collector.

### (Cell Production Step)

On the obtained positive electrode active material layer, a separator and a negative electrode active material layer containing graphite as the negative electrode active material were laminated, and these were dried under vacuum and arranged into a laminate film. By injecting an electrolytic solution into the laminate film and then sealing the laminate film, an evaluation cell of Example 1 was obtained.

### <<Evaluation>>

### <Charging/Discharging Test>

Based on the mass of the positive electrode active material included in the evaluation cell, with a current value of 130 mA/g defined as the 1 C rate, CCCV charging and discharging was performed at a voltage of 2.2 to 4.1 V, with a charging/discharging current value of 0.2 C and a final current value of 0.03 C. The obtained CCCV capacity was taken as the capacity of the cell.

### Example 2

An evaluation cell of Example 2 was obtained and evaluated in the same manner as in Example 1, except that a lithium antimony (Li₃Sb) alloy was used as the lithium alloy.

### Example 3

An evaluation cell of Example 3 was obtained and evaluated in the same manner as in Example 1, except that a lithium tin (LiSn) alloy was used as the lithium alloy.

### Comparative Example 1

A slurry was prepared by mixing a Li₃Bi alloy, LFP, a conductive aid, and a binder in NMP as the dispersion medium. The obtained slurry was applied onto an Al foil. Thereafter, the layer obtained through removing the NMP as the dispersion medium by drying was pressed to obtain an evaluation cell of Comparative Example 1, which was evaluated. It is noted that the Li₃Bi alloy and the LFP were mutually dispersed.

### Comparative Example 2

An evaluation cell of Comparative Example 2 was obtained and evaluated in the same manner as Comparative Example 1, except that a Li₃Sb alloy was used as the lithium alloy.

### Comparative Example 3

An evaluation cell of Comparative Example 3 was obtained and evaluated in the same manner as Comparative Example 1, except that a LiSn alloy was used as the lithium alloy.

### Comparative Example 4

An evaluation cell of Comparative Example 4 was obtained and evaluated in the same manner as Comparative Example 1, except that a lithium alloy was not used.

It is noted that the total volume of the positive electrode active material and lithium alloy contained in the positive electrode active material layer was designed to be the same in all of the Examples and Comparative Examples.

### <<Results>

Regarding the Examples and Comparative Examples described above, the contents and volumes of the LFP, the thicknesses of the layers containing the LFP, the types and alloying potentials of the metal elements constituting the lithium alloys, the contents and volumes of the lithium alloys, and the thicknesses of the lithium alloy layers are shown in Table 1.

TABLE 1

| | LFP | | | Li alloy | | | | | | | |
|---|---|---|---|---|---|---|---|---|---|---|---|
| | | | Thickness | | | | | | | | |
| | | | of layer | Metal element | | | | | Li alloy | Battery capacity | |
| | | | containing | | Alloying | | | | layer | (Initial charging/discharging) | |
| | Content | Vol | LFP | | potential | Content | Volume | State of | thickness | Charging | Discharging |
| | [mg] | [cc] | [μm] | Type | [V] | [mg] | [cc] | Li alloy | [μm] | [mAh] | [mAh] |
| Ex 1 | 93.6 | 0.0260 | 104 | Bi | 0.81 to 0.83 | 8.9 | 0.0018 | Layer formed on | 6 | 17.3 | 14.8 |
| | | | | | | | | surface closer to | | | |
| | | | | | | | | positive electrode | | | |
| | | | | | | | | current collector | | | |
| Ex 2 | 94.1 | 0.0262 | 105 | Sb | 0.94 to 0.96 | 5.5 | 0.0016 | Layer formed on | 5 | 17.4 | 14.9 |
| | | | | | | | | surface closer to | | | |
| | | | | | | | | positive electrode | | | |
| | | | | | | | | current collector | | | |
| Ex 3 | 89.5 | 0.0249 | 94 | Sn | 0.57 to 0.66 | 14.5 | 0.0029 | Layer formed on | 11 | 17.7 | 15.0 |
| | | | | | | | | surface closer to | | | |
| | | | | | | | | positive electrode | | | |
| | | | | | | | | current collector | | | |
| Comp Ex 1 | 93.6 | 0.0260 | 98 | Bi | 0.81 to 0.83 | 8.9 | 0.0018 | Dispersed in | — | 14.7 | 12.2 |
| | | | | | | | | positive electrode | | | |
| | | | | | | | | active material | | | |
| | | | | | | | | layer | | | |
| Comp Ex 2 | 94.1 | 0.0262 | 103 | Sb | 0.94 to 0.96 | 5.5 | 0.0016 | Dispersed in | — | 14.8 | 12.5 |
| | | | | | | | | positive electrode | | | |
| | | | | | | | | active material | | | |
| | | | | | | | | layer | | | |
| Comp Ex 3 | 89.5 | 0.0249 | 99 | Sn | 0.57 to 0.66 | 14.5 | 0.0029 | Dispersed in | — | 14.6 | 12.1 |
| | | | | | | | | positive electrode | | | |
| | | | | | | | | active material | | | |
| | | | | | | | | layer | | | |
| Comp Ex 4 | 100.0 | 0.0278 | 108 | — | — | — | — | — | — | 15.6 | 13.1 |

As shown in Table 1, the battery capacity was greater in the cells of the Examples, in which the lithium alloy was arranged on the surface of the positive electrode active material layer that was closer to the positive electrode current collector, than in the cells of Comparative Examples 1 to 3, in which the lithium alloy and the positive electrode active material were mutually dispersed in the positive electrode active material layer, and the cell of Comparative Example 4, which did not contain a lithium alloy.

### DESCRIPTION OF REFERENCE SIGNS

1 lithium-ion battery
10 positive electrode current collector
20 positive electrode active material layer
21 layer containing positive electrode active material
21a positive electrode active material
22 lithium alloy layer
22a lithium alloy
30 separator
40 negative electrode active material layer
50 negative electrode current collector

1. A positive electrode active material layer, which is interposed between a positive electrode current collector and a separator, wherein
the positive electrode active material layer comprises a positive electrode active material and a lithium alloy of lithium and a metal element,
the positive electrode active material is coated with a carbon material,
the metal element has an alloying potential with lithium of 0.5 V (vs. Li/Li⁺) or more, and the lithium alloy is arranged on a surface of the positive electrode active material layer that is closer to the positive electrode current collector and/or on a surface of the positive electrode active material layer that is closer to the separator.

2. The positive electrode active material layer according to claim 1, wherein the lithium alloy forms a lithium alloy layer.

3. The positive electrode active material layer according to claim 2, wherein the lithium alloy layer has a thickness of 1 μm or more and 20 μm or less.

4. The positive electrode active material layer according to claim 1, wherein the positive electrode active material is an olivine positive electrode active material.

5. The positive electrode active material layer according to claim 4, wherein the olivine positive electrode active material is at least one selected from lithium ferrous phosphate, lithium ferromanganese phosphate, lithium manganese phosphate, and lithium cobalt phosphate.

6. The positive electrode active material layer according to claim 1, wherein the metal element is at least one selected from bismuth, antimony, and tin.

7. The positive electrode active material layer according to claim 1, wherein the ratio of a mass of the positive electrode active material to a mass of the lithium alloy is 3.0 or more and 15.0 or less.

8. The positive electrode active material layer according to claim 1, wherein the positive electrode active material layer from which the lithium alloy is excluded has a thickness of 20 μm or more and 300 μm or less.

9. A lithium-ion battery, comprising:
the positive electrode current collector,
the separator, and
the positive electrode active material layer according to claim 1, which is interposed between the positive electrode current collector and the separator.

10. A lithium-ion battery, comprising:
a positive electrode current collector,
a separator, and
a positive electrode active material layer, which is interposed between the positive electrode current collector and the separator, wherein
the positive electrode active material layer contains a positive electrode active material and a metal element,
the positive electrode active material is coated with a carbon material,
the metal element has an alloying potential with lithium of 0.5 V (vs. Li/Li⁺) or more, and
the metal element is arranged on a surface of the positive electrode active material layer that is closer to the positive electrode current collector and/or on a surface of the positive electrode active material layer that is closer to the separator.

11. A method for manufacturing the positive electrode active material layer according to claim 1, comprising the following steps:
(a) applying a first slurry containing the lithium alloy and a first dispersion medium onto a base material,
(b) applying a second slurry containing the positive electrode active material and a second dispersion medium after the step (a),
(c) removing the first and second dispersion media by drying to obtain a laminate; and
(d) pressing the laminate.

12. The method according to claim 11, wherein the base material is a positive electrode current collector.

13. The method according to claim 11, further comprising, before the step (b), removing the first dispersion medium by drying to obtain a preliminary lithium alloy layer.

14. The method according to claim 13, further comprising pressing the preliminary lithium alloy layer to obtain a lithium alloy layer.

15. The method according to claim 11, wherein the first and second dispersion media are the same dispersion medium.
